(19) United States
(12) Patent Application Publication
(10) Pub. No.: US 2015/0062365 A1
(43) Pub. Date: Mar. 5, 2015

(54) METHOD FOR CAPTURING IMAGE AND ELECTRONIC DEVICE THEREOF

(71) Applicant: Samsung Electronics Co., Ltd., Suwon-si (KR)

(72) Inventors: Woo-Yong LEE, Hwaseong-si (KR); Dong-Hoon JANG, Suwon-si (KR)

(21) Appl. No.: 14/304,224

(22) Filed: Jun. 13, 2014

(30) Foreign Application Priority Data
Sep. 2, 2013 (KR) 10-2013-0105157

(51) Int. Cl. H04N 5/232

(52) U.S. Cl. CPC H04N 5/23245; H04N 5/23293; H04N 5/23212
USPC 348/222.1

(57) ABSTRACT

A method of operating an electronic device is provided. The method includes entering a camera capture mode according to a camera capture mode entry event, detecting a capture event, determining whether the capture event is detected within a predetermined time from the generation of the camera capture mode entry event or the entry of the camera capture mode, performing an instant capture when the capture event is detected within the predetermined time, and performing a normal capture when the capture event is detected after the predetermined time.

### CROSS-REFERENCE TO RELATED APPLICATION(S)

This application claims the benefit under 35 U.S.C. §119(a) of a Korean patent application filed on Sep. 2, 2013 in the Korean Intellectual Property Office and assigned Serial No. 10-2013-0105157, the entire disclosure of which is hereby incorporated by reference.

### TECHNICAL FIELD

Embodiments relates to a method for capturing an image and an electronic device thereof.

### BACKGROUND

In recent years, with the development of multimedia technologies, electronic devices with various functions have been introduced.

In general, such electronic devices have a convergence function to compositely perform one or more functions.

A mobile terminal called a “smart phone” is mostly used as a current electronic device. Such a mobile terminal includes a large-screen touch-type display module, and includes a high pixel camera module to capture a still image and a moving image in addition to a basic function of communicating with another party. Furthermore, the mobile terminal may play multimedia contents such as music and moving images and may access a network to perform web surfing.

Such electronic devices have advanced to more rapidly perform various convergence functions by including a high-performance processor, and have been remarkably developed so that the function of communication with the other party is rather regarded as an additional function. However, in addition to such advanced functions, there exists a need for an improved apparatus and method for capturing an image with immediacy.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for capturing an image with immediacy and an electronic device thereof.

Another aspect of the present disclosure is to provide a method for capturing an image, which is intuitively operated, and an electronic device thereof.

In accordance with an aspect of the present disclosure, a method of an electronic device is provided. The method includes entering a camera capture mode according to a camera capture mode entry event, detecting a capture event, determining whether the capture event is detected within a predetermined time from generation of the camera capture mode entry event or the entry of the camera capture mode, and performing an instant capture when the capture event is detected within the predetermined time, and performing a normal capture when the capture event is detected after the predetermined time.

Performing the instant capture may use fixed focusing.

Performing the instant capture may not generate thumbnail information on an image generated by the instant capture.

Performing the instant capture may include omitting at least a part of contents of EXchangeable Image File Format (EXIF) information on an image generated by the instant capture.

Performing the instant capture may include applying a low compression rate to an image generated by the instant capture.

Performing the instant capture may include performing the instant capture in a state that a preview is not displayed.

The method may further include setting an environment of a camera for the instant capture and the normal capture after the entering of the camera capture mode.

Setting the environment of the camera for the instant capture may include increasing the frequency of a clock of a processor of the electronic device to be greater than the frequency of the clock in a normal state.

Setting the environment of the camera for the instant capture may include setting a priority of a task for the instant capture to the highest level.

Setting the environment of the camera for the instant capture may include using a memory area to be used in the instant capture as a predefined memory area.

Setting the environment of the camera for the instant capture may include maintaining a memory area to be used for the capture without the memory release.

The method may further include setting an environment of a camera for the instant capture and the normal capture after determining whether the capture event is detected within a predetermined time from the generation of the camera capture mode entry event or the entry of the camera capture mode.

The method may further include, when performing the instant capture, detecting a second capture event, determining whether the second capture event is detected within a second predetermined time from start of the instant capture, and further performing the instant capture when the second capture event is detected within the second predetermined time.

According to another aspect of the present disclosure, an electronic device is provided. The electronic device includes at least one camera module, a memory, and at least one processor, wherein the processor is configured to enter a camera capture mode according to a camera capture mode entry event, detect a capture event, determine whether the capture event is detected within a predetermined time from generation of the camera capture mode entry event or the entry of the camera capture mode, and perform control such that an instant capture is performed when the capture event is detected within the predetermined time.

The capture event may include input of a capture button or input of a specific key.

The processor may be further configured to set an environment of a camera for the instant capture after the processor enters the camera capture mode.

The processor may be further configured to set an environment of a camera for the instant capture after the processor determines whether the capture event is detected within a predetermined time from generation of the camera capture mode entry event or the entry of the camera capture mode.

When performing the instant capture, the processor may be further configured to detect a second capture event, determine whether the second capture event is detected within a second predetermined time from start of the instant capture, and further perform the instant capture when the second capture event is detected within the second predetermined time.

In accordance with another aspect of the present disclosure, a method of an electronic device is provided. The method includes entering a camera capture mode according to a camera capture mode entry event, setting an environment of a camera for an instant capture and a normal capture, detecting a capture event, determining whether the capture event is detected within a predetermined time from the entry of the camera capture mode, performing an instant capture when the capture event is detected within the predetermined time, and performing a normal capture when the capture event is detected after the predetermined time.

The operation method may further include, when performing the instant capture, detecting a second capture event, determining whether the second capture event is detected within a second predetermined time from start of the instant capture, and further performing the instant capture when the second capture event is detected within the second predetermined time.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view of an electronic device according to one embodiment of the present disclosure;

FIG. 2A is a block diagram of an electronic device according to one embodiment of the present disclosure;

FIG. 2B is a block diagram of a processor according to one embodiment of the present disclosure;

FIG. 3 is a flowchart illustrating a method of operating an electronic device according to one embodiment of the present disclosure;

FIG. 4 is a flowchart illustrating a method of operating an electronic device according to one embodiment of the present disclosure;

FIG. 5 is a flowchart illustrating a method of operating an electronic device according to an embodiment of the present disclosure; and

FIG. 6 is a flowchart illustrating a method of operating an electronic device according to one embodiment of the present disclosure.

FIG. 7 is a flowchart illustrating a method of operating an electronic device according to one embodiment of the present disclosure; and

FIGS. 8A and 8B are diagrams illustrating a screen configuration for describing a method of operating an electronic device according to one embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Various embodiments of the present disclosure will illustrate and describe an electronic device which includes one or more camera modules and to which a touch screen is applicable as a display unit. However, it is to be understood that the present disclosure is not limited thereto. For example, the electronic device may include various devices, such as a Personal Digital Assistant (PDA), a laptop computer, a mobile phone, a smart phone, a net book, a TV, a Mobile Internet Device (MID), an Ultra-Mobile PC (UMPC), a tablet PC, a watch, a camera device, a navigation device, an MP3, and a wearable device, each of which includes one or more camera modules.

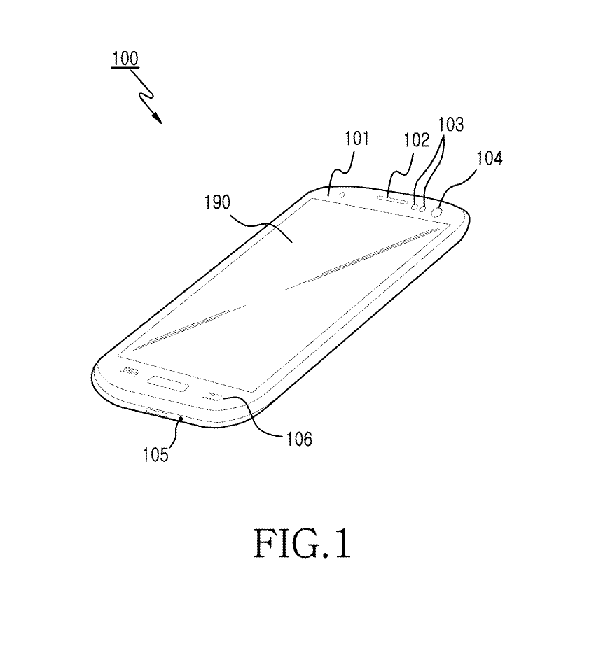

FIG. 1 is a perspective view of an electronic device according to one embodiment of the present disclosure.

Referring to FIG. 1, a touch screen 190 may be installed on a front surface 101 of the electronic device 100. The touch screen 190 may display an electric signal provided from the electronic device 100 as an image such as a text, a graphic, a video, etc. In addition, data input/output may be simultaneously possible in the touch screen 190 by applying a touch panel. The touch screen 190 may receive data by an input device such as a finger, a stylus, etc.

An ear piece 102 configured to project sounds may be installed at an upper side of the touch screen 190. A plurality of sensors 103, such as a proximity sensor, an illumination sensor, etc., for the purpose of the use convenience in the electronic device 100, and a camera module 104 for capturing a subject may be installed at one side of the ear piece 102.

According to one embodiment of the present disclosure, the electronic device 100 may further include a microphone device 105 provided at lower side of the touch screen 190 to receive sounds, and a key pad device 106 in which key buttons are arranged. However, the present disclosure is not limited thereto. That is, various additional devices for implementing other additional known functions may be further installed.

According to an embodiment of the present disclosure, the electronic device 100 may be applicable as a wearable device. In this case, the electronic device 100 may be put on a portion of the human body, and the elements of the electronic device 100 may be flexibly configured.

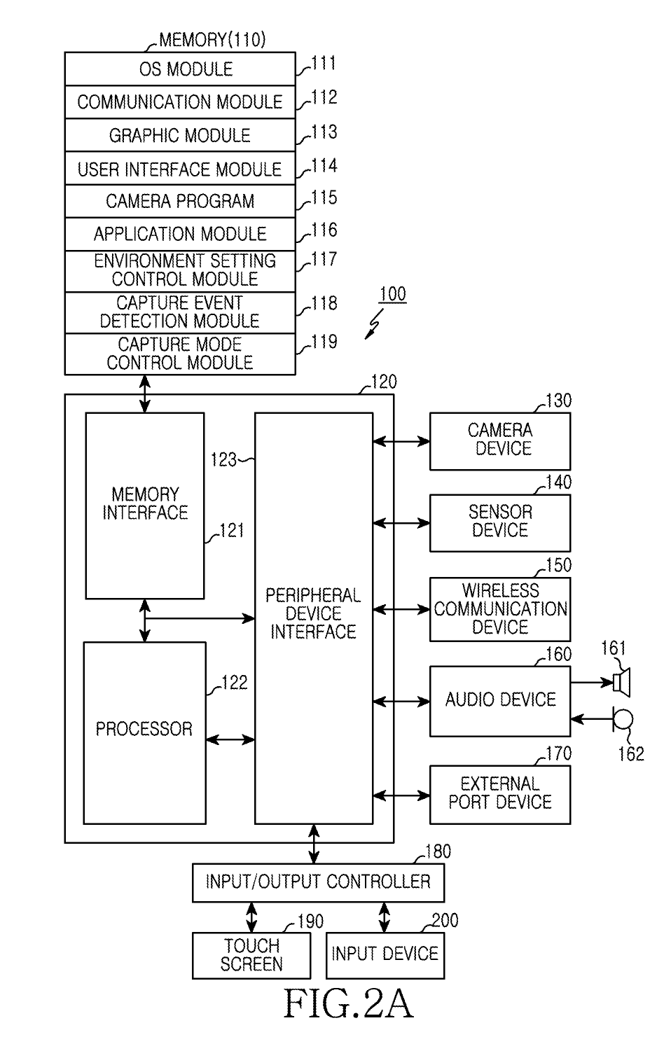

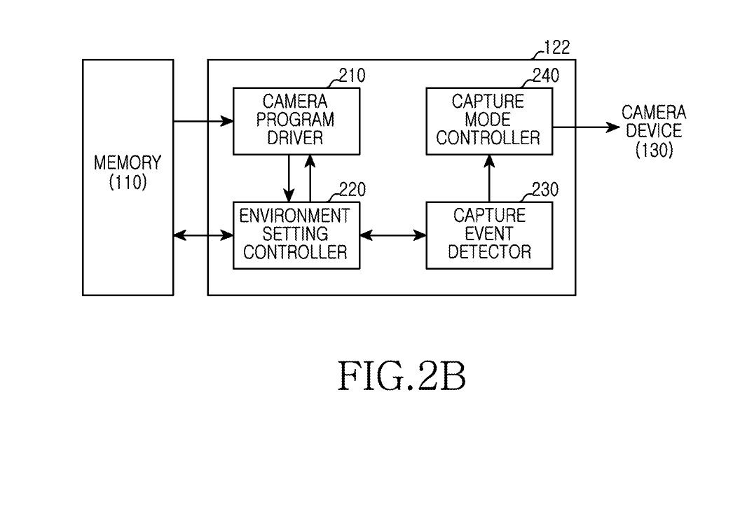

FIG. 2A is a block diagram of an electronic device according to one embodiment of the present disclosure.

Referring to FIG. 2A, the electronic device 100 may be a device, such as a PDA, a lap top computer, a mobile phone, a smart phone, a netbook, a handheld computer, an MID, a UMPC, a tablet PC, a note PC, a watch, a navigation device, an MP3, a camera device, and a wearable device. In addition, the electronic device 100 may be a predetermined device including a combination of at least two functions among the above devices.

According to one embodiment of the present disclosure, the electronic device 100 may include a memory 110, a processor unit 120, a camera device 130, a sensor device 140, a wireless communication device 150, an audio device 160, an external port device 170, an input/output controller 180, a touch screen 190, and an input device 200. The electronic device 100 may include a plurality of memories 110 and a plurality of external port devices 170.

The respective elements will be described below.

The processor unit 120 may include a memory interface 121, at least one processor 122, and a peripheral device interface 123. The memory interface 121, the at least one processor 122, and the peripheral device interface 123, which are included in the processor unit 120, may be integrated into a single Integrated Circuit (IC) or may be implemented as separate elements.

The memory interface 121 may control access of an element, such as the processor 122 or the peripheral device interface 123, to the memory 110.

The peripheral device interface 123 may control the connection of an input/output peripheral device of the electronic device 100 to the processor 122 and the memory interface 121.

The processor 122 may perform control such that the electronic device 100 provides various multimedia services using at least one software program. The processor 122 may execute at least one program stored in the memory 110 to provide a service corresponding to the at least one program.

The processor 122 may execute a plurality of software programs to perform various functions for the electronic device 100 and may process and control speech communication, image communication, and data communication. In addition, the processor 122 may perform methods of various embodiments according to the present disclosure in cooperation with the software modules stored in the memory 110.

The processor 122 may include at least one data processor, image processor, or CODEC. Moreover, in the electronic device 100, the data processor, the image processor, or the CODEC may be separately configured.

The various elements of the electronic device 100 may be connected to each other through at least one communication bus (assigned with no reference numeral) or electric connection unit (assigned with no reference numeral).

The camera device 130 may perform camera functions such as capturing a photograph, a video clip, and recording. The camera device 130 may include a Charge-Coupled Device (CCD) or a Complementary Metal-Oxide Semiconductor (CMOS) device. In addition, the camera device 130 may modify the hardware configuration according to a camera program executed by the processor 122. For example, the camera device 130 may move a lens and change the number of apertures according to the camera program executed by the processor 122.

According to one embodiment of the present disclosure, the camera device 130 may provide a collected image acquired by capturing the subject to the processor unit 120. The camera device 130 may include an image sensor to convert an optical signal into an electric signal, an image processor to convert an analog image signal into a digital image signal, and a signal processor to process an image so that the digital image signal output from the image processor may be displayed on the touch screen 190.

The sensor device 140 may include a proximity sensor, a Hall sensor, an illumination sensor, a motion sensor, and the like. For example, the proximity sensor may detect an object approaching the electronic device 100, and the Hall sensor may detect a magnetic force of a metallic member. In addition, the illumination sensor may detect ambient light of the electronic device 100, and the motion sensor may include an acceleration sensor or a gyro sensor to detect a motion of the electronic device 100. However, the present disclosure is limited thereto, and the sensor device 140 may further include various sensors to implement other additional known functions.

The wireless communication device 150 may perform wireless communication and may include a Radio Frequency (RF) transceiver or a light (for example, infrared) transceiver. Although not illustrated, the wireless communication device 150 may include an RF IC unit and a baseband processor. The RF IC unit may transmit/receive an electromagnetic wave, convert a baseband signal from the baseband processor into the electromagnetic wave, and transmit the electromagnetic wave through an antenna. The RF IC unit may include an RF transceiver, an amplifier, a tuner, an oscillator, a digital signal processor, a CODEC chipset, a Subscriber Identity Module (SIM) card, and the like.

The wireless communication device 150 may be implemented to operate through at least one of a GSM network, an EDGE network, a CDMA network, a W-CDMA network, an LTE network, an OFDMA network, a Wi-Fi network, a WiMax network, an NFC network, an infrared communication network, and a Bluetooth network, depending on a communication network. However, the present disclosure is not limited thereto. That is, various communication schemes using protocols for an e-mail, instant messaging or a Short Message Service (SMS) are applicable to the wireless communication device 150.

The audio device 160 may be connected to a speaker 161 and a microphone 162 to perform audio input and output functions, such as speech recognition, sound duplication, digital recording, call functions, etc. The audio device 160 may provide an audio interface between the user and the electronic device 100, and may convert a data signal received from the processor 122 into an electric signal and output the converted electric signal through the speaker 161. The speaker 161 may convert a frequency band of the electric signal into an audible frequency band and output a signal with the audible frequency band, and may be disposed forward or rearward of the electronic device 100. The speaker 161 may include a flexible film speaker with one vibration film to which at least one piezoelectric element is attached.

The microphone 162 may convert an acoustic wave provided from persons or other sound sources into an electric signal. The audio device 160 may receive the electric signal from the microphone 162, convert the received electric signal into an audio data signal, and transmit the converted audio data signal to the processor 122. The audio device 160 may include an ear phone, an ear set, a head phone, or a headset which are attachable to and detachable from the electronic device 100.

The external port device 170 may directly connect the electronic device 100 to an electronic device of the other party or may indirectly connect the electronic device 100 to the electronic device of the other party through a network (for example, Internet, intranet, wireless LAN, and the like). The external port device 170 may include a USB port, a FIREWIRE port, etc.

The input/output controller 180 may provide an interface between input/output devices, such as the touch screen 190 and the input device, and the peripheral device interface 123. The input/output controller 180 may include a touch screen controller and other input device controllers.

The touch screen 190 may provide input and output interfaces between the electronic device 100 and the user. The touch screen 190 may transfer touch information of the user to the processor 122, and may allow visual information, a text, a graphic, or a video provided from the processor 122 to be viewed by the user by applying a touch detection technology.

The touch screen 190 may display state information of the electronic device 100, and characters input by the user, moving images, and still images. Furthermore, the touch screen 190 may display information on an application driven by the processor 122.

The touch screen 190 may apply a predetermined multi-touch detection technology with other proximity sensor array or other elements as well as capacitive, resistive, infrared and surface acoustic wave technologies. The touch screen 190 may include at least one of a Liquid Crystal Display (LCD), an Organic Light-Emitting Diode (OLED), an Active Matrix Organic Light Emitting Diode (AMOLED), a Thin Film Transistor-Liquid Crystal Display (TFT-LCD), a flexible display, a 3D display, etc.

The touch screen 190 may recognize a touch through a variation in a physical amount according to contact by a finger or a stylus, and may detect operations such as flicking, touch-and-drag, tap-and-hold, multi-tap, etc. In addition, the touch screen 190 may be implemented to recognize a hovering input (non-contact touch or proximity touch) by detecting that an input device such as the finger or the stylus approaches within a predetermined distance of the touch screen 190.

The input device 200 may provide input data generated by selection of the user to the processor 122 through the input/output controller 180. The input device 200 may include a key pad with at least one hardware button and a touch pad to detect touch information.

The input device 200 may include an up/down button to control a volume. The input device 200 may further include at least one of a push button, a locker button, a locker switch, a thumb-wheel, a dial, a stick, a mouse, a track ball, a pointer device such as a stylus, etc., each of which has a corresponding function.

The memory 110 may include a nonvolatile memory or a high-speed random access memory such as at least one magnetic disc storage device, at least one optical storage device, or a flash memory (for example, NAND memory, NOR memory, or the like).

The memory 110 stores software, and the software may include an Operating System (OS) module 111, a communication module 112, a graphic module 113, a user interface module 114, a camera program 115, an application module 116, an environment setting control module 117, a capture event detection module 118, and a capture mode control module 119. The term “module” may also be expressed as a group of commands, a command set, or a program.

The OS module 111 may include a built-in OS such as WINDOWS, LINUX, Darwin, RTXC, UNIX, OS X, Android, VxWorks, etc., and may include various software elements for controlling an operation of a general system. The control of the general system control may include control and management of a memory, control and management of storage hardware (device), and control and management of power. Furthermore, the OS module 111 may perform a function to easily perform communication between various hardwares (devices) and various software elements (modules).

The communication module 112 may allow the electronic device 100 to communicate with an electronic device of another party such as a computer, a server, and an electronic device through the wireless communication device 150 or the external port device 170.

The graphic module 113 may include various software elements to provide and display a graphic to the touch screen 190. The term “graphic” may mean a text, a web page, an icon, a digital image, a video, an animation, etc.

The user interface module 114 may include various software elements associated with user interface. The user interface module 114 may control the touch screen 190 to display information on an application driven by the processor 122. Furthermore, the user interface module 114 may include contents regarding how to change a state of the user interface or contents regarding in which condition a state of the user interface varies.

The camera program 115 may include various software elements for a camera capturing function.

The application module 116 may include software elements with respect to at least one application installed in the electronic device 100. The application may include a browser, an e-mail, a phone-book, a game, an SMS, a multimedia message service, a Social Network Service (SNS), an instant message, a morning call, an MP3, time management, a drawing board, a camera, word processing, a keyboard emulation, a music player, an address book, a contacts list, a widget, a Digital Rights Management (DRM), speech recognition, sound duplication, a location determining function, and a location-based service. The term “application” may be expressed as an application program.

The environment setting control module 117 may include a software element to set an environment of the electronic device 100 for the camera function. The environment setting control module 117 may include a process and related commands corresponding to environment setting for an instant capture and a normal capture.

The capture event detection module 118 may include a software element to detect a capture button input or a specific key button input for capturing an image in a camera capture mode. The capture event detection module 118 may determine whether a capture event is detected within a predetermined time from entry of the camera capture mode. Furthermore, the electronic device 100 may include a process and commands to determine whether the capture event is detected within a predetermined time from the start of the instant capture.

The capture mode control module 119 may include software elements to perform the normal capture and the instant capture in the camera capture mode. The capture mode control module 119 may include a process and commands to perform control such that the normal capture or the instant capture is performed based on a predetermined criterion.

The processor unit 120 may further include additional modules (commands) in addition to the above modules.

Various functions of the electronic device 100 may be executed by hardware or software including at least one processor or Application Specified Integrated Circuit (ASIC).

Although not illustrated, the electronic device 100 may include a power system to supply power to various elements included in the electronic device 100. The power system may include a power supply (an AC power supply or a battery), a power error detection circuit, a power converter, a power inverter, a charging device, or a power state display device (e.g., LED). In addition, the electronic device 100 may include a power management and control device to perform generation, management, and distribution functions of power.

Although the above description has illustrated and described elements of the electronic device 100, the present disclosure is not limited thereto.

For example, the electronic device 100 may include more or fewer elements shown in drawings.

In addition, when the electronic device 100 is implemented by a wearable device which may be worn in a human body, the elements may be flexibly configured.

FIG. 2B is a block diagram of a processor according to one embodiment of the present disclosure.

Referring to FIG. 2B, the processor 122 may include a camera program driver 210, an environment setting controller 220, a capture event detector 230, and a capture mode controller 240.

According to one embodiment of the present disclosure, elements of the processor 122 may be configured by separate modules, but may be included as elements of software in one module according to another embodiment.

The camera program driver 210 may execute the camera program 115 stored in the memory 110 to provide a service corresponding to a camera function.

According to one embodiment of the present disclosure, the camera program driver 210 may load the camera program 115 to control a user interface for operating the camera function to be displayed on the touch screen 190 as a graphic.

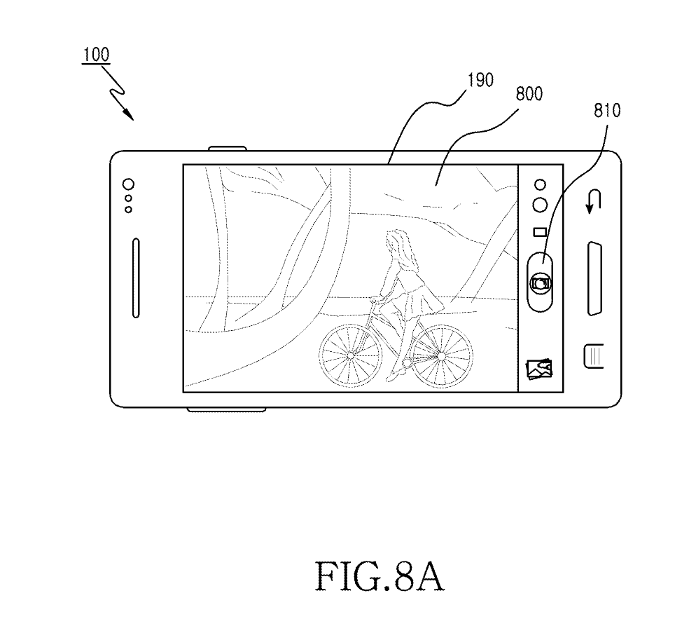

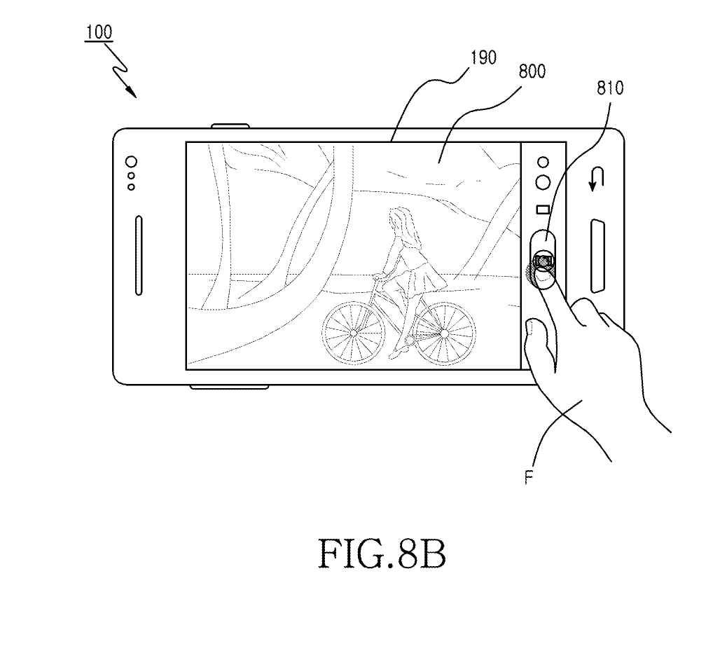

FIGS. 8A and 8B are diagrams illustrating a screen configuration for describing the operation method of the electronic device according to one embodiment of the present disclosure.

Referring to FIGS. 8A and 8B, the electronic device 100 may execute a specific application or may enter a camera capture mode according to a camera capture mode entry event such as input of a specific key. When entering the camera capture mode, the electronic device 100 may output a background image 800 received through a camera sensor to the touch screen 190 as illustrated in FIG. 8A. Furthermore, the electronic device 100 may display a capture button 810 for capturing the background image 800 output to the touch screen 190. As illustrated in FIG. 8B, when the capture button 810 for capture is selected by an input means such as a finger F or a touch pen, the electronic device 100 may capture the background image 800 which is currently output.

Referring again to FIG. 2B, the environment setting controller 220 may execute the environment setting control module 117 stored in the memory 110 to set an environment of the electronic device 100 for an instant capture function or a normal capture function. The term “instant capture” denotes an operation in which the electronic device 100 performs camera capture within a predetermined time from entry of a camera capture mode. The term “normal capture” denotes an operation in which the electronic device 100 performs camera capture after a predetermined time from the entry of a camera capture mode.

According to one embodiment of the present disclosure, the environment setting for the instant capture may perform at least one of following operations.

First, a processing speed for capture may be increased by increasing the clock frequency of the processor 122. For example, the environment setting controller 220 may perform control such that the clock frequency of the processor 122 is maintained to be greater than that in a normal state.

Second, a processing time required for capture may be reduced by setting a priority of a task for capture to the highest level. For example, the environment setting controller 220 may perform control such that a task for capture is first processed among a plurality of currently processed tasks.

Third, a processing time required for an allocation operation of a memory may be reduced by defining a memory necessary for capture as a designated memory area. For example, the environment setting controller 220 may designate a predefined memory area as a memory area to be used for capture.

Fourth, memory release may be performed when a predetermined time has elapsed or when an instant capture is terminated after a memory area to be used for the capture maintains without the memory release. For example, the environment setting controller 220 may perform the memory release for a continuous instant capture when the predetermined time elapses or when the instant capture is terminated.

As described above, the environment setting controller 220 may perform at least one of the above operations to set an environment of the electronic device 100 for the instant capture.

According to an embodiment of the present disclosure, the environment setting for the normal capture may perform at least one of following operations.

First, the environment setting controller 220 may perform control such that the clock frequency of the processor 122 is maintained in a normal state.

Second, the environment setting controller 220 may perform control such that a priority of a task for capture is maintained in the normal state.

Third, the environment setting controller 220 may optimize the use of a memory by using a heap memory as a memory necessary for the capture.

Fourth, the environment setting controller 220 may provide other additional functions, such as a filter effect with respect to the capture, a face recognition function, a multi-frame function, etc.

As described above, the environment setting controller 220 may perform at least one of the above operations to set an environment of the electronic device 100 for the normal capture.

The capture event detector 230 may execute the capture event detection module 118 stored in the memory 110 to confirm whether a capture event is detected within a preset time.

According to one embodiment of the present disclosure, the capture event detector 230 may confirm a selected time point of the capture button 810 as illustrated in FIG. 8B.

In one embodiment, the capture event detector 230 may determine whether the selected capture button 810 is detected within a predetermined time from entry of the camera capture mode.

For example, the predetermined time may be about two seconds, but the present disclosure is not limited thereto.

According to an embodiment of the present disclosure, the capture event detector 230 may determine whether the selected capture button 810 is detected within a predetermined time from generation of a camera capture mode entry event.

As described above, the capture event detector 230 may provide information on a detected time point of a capture event to the capture mode controller 240.

In one embodiment, the capture mode controller 240 may execute the capture mode control module 119 stored in the memory 110 to perform control such that an instant capture function or a normal capture function is performed.

According to one embodiment of the present disclosure, the capture mode controller 240 may control such that an instant capture or a normal capture is performed according to capture event information provided from the capture event detector 230. For example, when the capture event is detected within the predetermined time from the entry of the camera capture mode, the capture mode controller 240 may perform control such that the instant capture is performed.

Meanwhile, when the capture event is detected after the predetermined time from the entry of the camera capture mode, the capture mode controller 240 may control such that the normal capture is performed.

According to one embodiment of the present disclosure, the instant capture may denote performance of at least one of the following operations.

First, a fixed focusing may be used to capture the image.

Second, thumbnail information on the image generated by the capture is not generated, and update of a database may be omitted.

Third, only basic Exchangeable Image File Format (EXIF) information (for example, captured weather, resolution, and the like) on the image generated by the capture may be displayed.

Fourth, a low compression rate may be applied to the image generated by the capture.

Fifth, when entering a camera capture mode, the capture is possible regardless of preview.

According to an embodiment, the normal capture may denote performance of at least one of following operations.

First, Automatic Focusing (AF), Continuous Focusing (CF), or face recognition focusing Fully Digital Auto Focusing (FDAF) may be used to capture the image.

Second, thumbnail information with respect to the image generated by the capture may be generated.

Third, a high compression rate may be applied to the image generated by the capture.

Fourth, when entering the camera capture mode, the electronic device 100 may display a preview to perform the capture.

According to various embodiments of the present disclosure, as described above, the instant capture, the environment setting for the instant capture, the normal capture, and the environment setting for the normal capture are defined, but the present disclosure is not limited thereto. For example, conditions corresponding to the instant capture, the environment setting for the instant capture, the normal capture, and the environment setting for the normal capture may be added or eliminated.

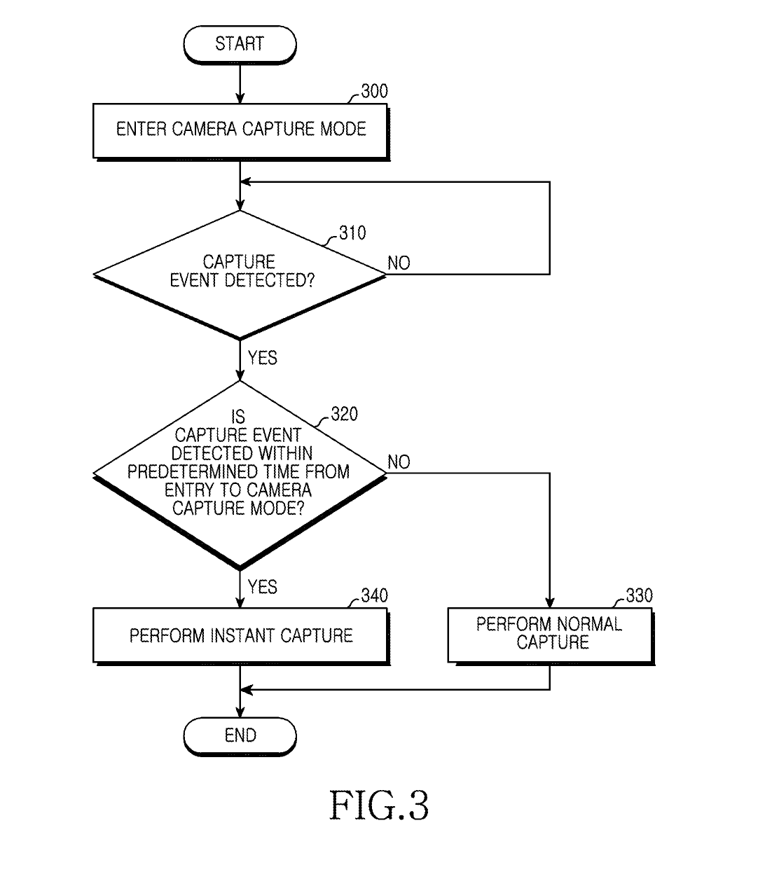

FIG. 3 is a flowchart illustrating a method of operating an electronic device according to one embodiment of the present disclosure.

Referring to FIG. 3, the electronic device 100 may enter the camera capture mode in operation 300.

According to one embodiment of the present disclosure, the electronic device 100 may execute a specific application or may enter the camera capture mode according to a camera capture mode entry event such as input of a specific key. When entering the camera capture mode, the electronic device 100 may output a background image 800 received through a camera sensor to the touch screen 190 as illustrated in FIG. 8A. Furthermore, the electronic device 100 may display a capture button 810 to capture the background image 800 output to the touch screen 190. As illustrated in FIG. 8B, when the capture button 810 for capture is selected by an input device such as a finger F or a touch pen, the electronic device 100 may capture the background image 800 which is currently output.

In operation 310, the electronic device 100 may determine whether a capture event is detected.

According to one embodiment of the present disclosure, the capture event detector 230 of the electronic device 100 may detect an input with respect to the capture event such as selection of a capture button or a specific key input to perform the capture.

When the capture event is detected, the electronic device 100 may determine whether the capture event is detected within a predetermined time from entry to the camera capture mode in operation 320.

According to one embodiment of the present disclosure, the capture event detector 230 of the electronic device 100 may determine whether the capture event is detected within a preset time.

According to one embodiment of the present disclosure, the capture event detector 230 may confirm a selected time point of the capture button 810 as illustrated in FIG. 8B. The capture event detector 230 may determine whether the selected capture button 810 is detected within a predetermined time from the entry to the camera capture mode.

For example, the predetermined time may be about two seconds, but the present invention disclosure is not limited thereto.

According to an embodiment of the present disclosure, the capture event detector 230 may determine whether the selected capture button 810 is detected with a predetermined time from generation of a camera capture mode entry event.

When the capture event is detected after the predetermined time from the entry to the camera capture mode, the electronic device 100 may perform normal capture in operation 330.

According to one embodiment of the present disclosure, when the capture event is detected after the predetermined time from the entry to the camera capture mode, the capture mode controller 240 of the electronic device 100 may perform control such that the normal capture is performed.

According to one embodiment of the present disclosure, the normal capture may denote performance of at least one of following operations.

First, AF, CF, or face recognition focusing FDAF may be used to capture the image.

Second, thumbnail information with respect to the image generated by the capture may be generated.

Third, a high compression rate may be applied to the image generated by the capture.

Fourth, when the electronic device 100 enters the camera capture mode, the electronic device 100 may display a preview to perform the capture.

On the other hand, when the capture event is detected within the predetermined time from the entry to the camera capture mode, the electronic device 100 may perform the instant capture in operation 340.

According to one embodiment of the present disclosure, when the capture event is detected within the predetermined time from the entry to the camera capture mode, the capture mode controller 240 of the electronic device 100 may perform control such that the instant capture is performed.

According to one embodiment of the present disclosure, the instant capture may denote performance of at least one of following operations.

First, a fixed focusing may be used to capture the image.

Second, thumbnail information on the image generated by the capture is not generated, and update of a database may be omitted.

Third, only basic EXIF information (for example, captured weather, resolution, and the like) on the image generated by the capture may be displayed.

Fourth, a low compression rate may be applied to the image generated by the capture.

Fifth, when entering a camera capture mode, the capture is possible regardless of preview.

According to various embodiments of the present disclosure, as described above, the instant capture and the normal capture are defined, but the present disclosure is not limited thereto. For example, conditions corresponding to the instant capture and the normal capture may be added or eliminated.

A command set for the respective operations may be stored in the above memory 110 as at least one module. In this case, the modules stored in the memory 110 may be executed by at least one processor 122.

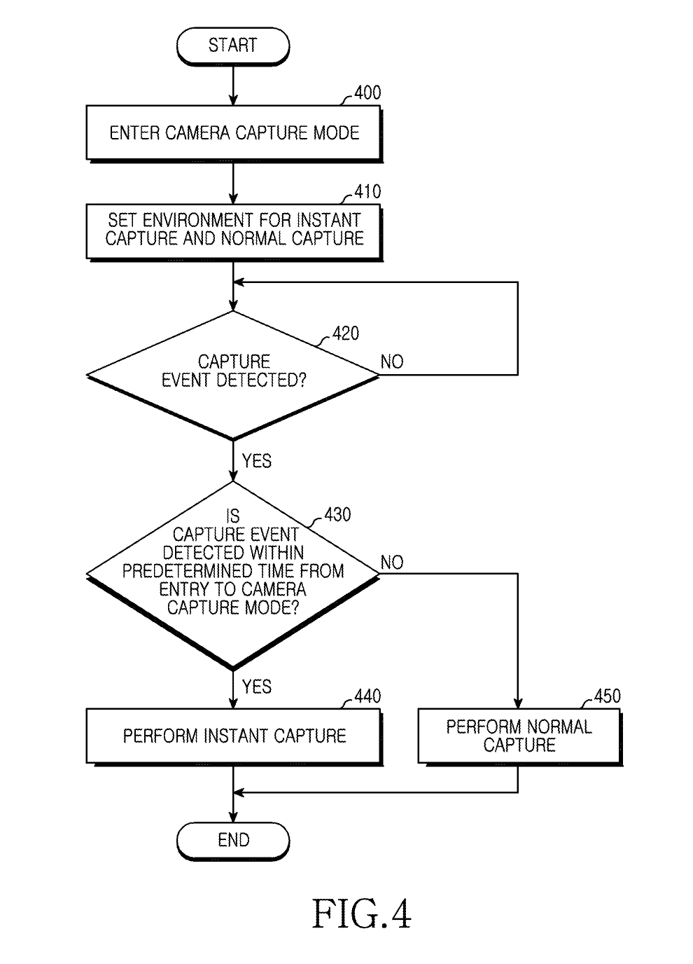

FIG. 4 is a flowchart illustrating a method of operating an electronic device according to one embodiment of the present disclosure.

Referring to FIG. 4, the electronic device 100 may enter the camera capture mode in operation 400.

According to one embodiment of the present disclosure, the electronic device 100 may execute a specific application or may enter the camera capture mode according to a camera capture mode entry event such as input of a specific key. When entering the camera capture mode, the electronic device 100 may output a background image 800 received through a camera sensor to the touch screen 190 as illustrated in FIG. 8A. Furthermore, the electronic device 100 may display a capture button 810 to capture the background image 800 output to the touch screen 190. As illustrated in FIG. 8B, when the capture button 810 for capture is selected by an input device such as a finger F or a touch pen, the electronic device 100 may capture the background image 800 which is currently output.

In operation 410, the electronic device 100 may set environments for an instant capture and a normal capture.

According to one embodiment of the present disclosure, the environment setting controller 220 of the electronic device 100 may set environments of the electronic device 100 for instant capture and normal capture functions.

According to one embodiment of the present disclosure, the environment setting for the instant capture may perform at least one of following operations.

First, a processing speed for capture may be increased by increasing the clock frequency of the processor 122. For example, the environment setting controller 220 may perform control such that the clock frequency of the processor 122 is maintained to be greater than that in a normal state.

Second, a processing time required for capture may be reduced by setting a priority of a task for capture to the highest level. For example, the environment setting controller 220 may perform control such that a task for capture is first processed among a plurality of current processed tasks.

Third, a processing time required for an allocation operation of a memory may be reduced by defining a memory necessary for capture as a designated memory area. For example, the environment setting controller 220 may designate a predefined memory area as a memory area to be used for capture.

Fourth, memory release may be performed when a predetermined time elapses or when an instant capture is terminated after a memory area to be used for the capture maintains without the memory release. For example, the environment setting controller 220 may perform the memory release for a continuous instant capture when the predetermined time elapses or when the instant capture is terminated.

As described above, the environment setting controller 220 may perform at least one of the above operations to set environments of the electronic device 100 for the instant capture.

According to one embodiment of the present disclosure, the environment setting for the normal capture may perform at least one of following operations.

First, the environment setting controller 220 may perform control such that the clock frequency of the processor 122 is maintained in a normal state.

Second, the environment setting controller 220 may perform control such that a priority of a task for capture is maintained in the normal state.

Third, the environment setting controller 220 may optimize the use of a memory by using a heap memory as a memory necessary for the capture.

Fourth, the environment setting controller 220 may provide other additional functions, such as a filter effect with respect to capture, a face recognition function, a multi-frame function, etc.

As described above, the environment setting controller 220 may perform at least one of the above operations to set an environment of the electronic device 100 for the normal capture.

In operation 420, the electronic device 100 may determine whether a capture event is detected.

According to one embodiment of the present disclosure, the capture event detector 230 of the electronic device 100 may detect an input with respect to the capture event such as selection of a capture button or a specific key input to perform the capture.

When the capture event is detected, the electronic device 100 may determine whether the capture event is detected within a predetermined time from entry to the camera capture mode in operation 430.

According to one embodiment of the present disclosure, the capture event detector 230 of the electronic device 100 may determine whether the capture event is detected within a preset time.

According to one embodiment of the present disclosure, the capture event detector 230 may confirm a selected time point of the capture button 810 as illustrated in FIG. 8B. The capture event detector 230 may determine whether the selected capture button 810 is detected within a predetermined time from the entry to the camera capture mode. For example, the predetermined time may be about two seconds, but the present disclosure is not limited thereto.

According to another embodiment of the present disclosure, the capture event detector 230 may determine whether the selected capture button 810 is detected with a predetermined time from generation of a camera capture mode entry event.

When the capture event is detected within the predetermined time from the entry to the camera capture mode, the electronic device 100 may perform the instant capture in operation 440.

According to one embodiment of the present disclosure, when the capture event is detected within the predetermined time from the entry to the camera capture mode, the capture mode controller 240 of the electronic device 100 may perform control such that the instant capture is performed.

According to one embodiment of the present disclosure, the instant capture may denote performance of at least one of following operations.

First, a fixed focusing may be used to capture the image.

Second, thumbnail information on the image generated by the capture is not generated, and update of a database may be omitted.

Third, only basic EXIF information (for example, captured weather, resolution, and the like) on the image generated by the capture may be displayed.

Fourth, a low compression rate may be applied to the image generated by the capture.

Fifth, when entering a camera capture mode, the capture is possible regardless of preview.

When the capture event is detected after the predetermined time from the entry to the camera capture mode, the electronic device 100 may perform a normal capture in operation 450.

According to one embodiment of the present disclosure, when the capture event is detected after the predetermined time from the entry to the camera capture mode, the capture mode controller 240 of the electronic device 100 may perform control such that the normal capture is performed.

According to one embodiment of the present disclosure, the normal capture may denote performance of at least one of following operations.

First, AF, CF, or face recognition focusing FDAF may be used to capture the image.

Second, thumbnail information with respect to the image generated by the capture may be generated.

Third, a high compression rate may be applied to the image generated by the capture.

Fourth, when entering the camera capture mode, the electronic device 100 displays preview to perform the capture.

According to various embodiments of the present disclosure, as described above, the instant capture, the environment setting for the instant capture, the normal capture, and the environment setting for the normal capture are defined, but the present disclosure is not limited thereto. For example, conditions corresponding to the instant capture, the environment setting for the instant capture, the normal capture, and the environment setting for the normal capture may be added or eliminated.

A command set for the respective operations may be stored in the above memory 110 as at least one module. In this case, the modules stored in the memory 110 may be executed by at least one processor 122.

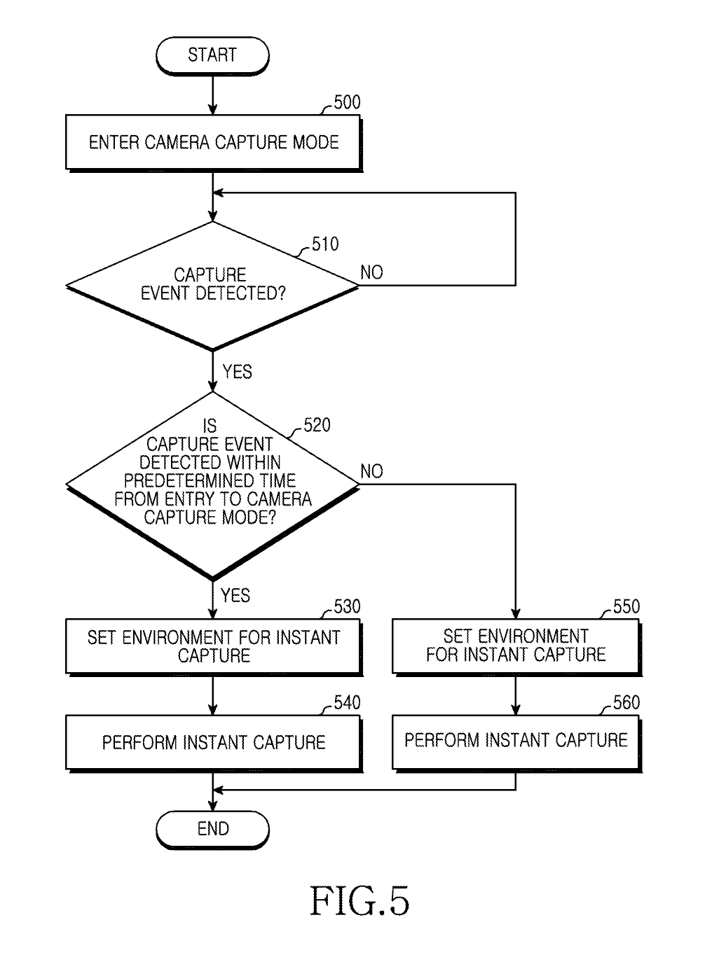

FIG. 5 is a flowchart illustrating a method of operating an electronic device according to one embodiment of the present disclosure.

Referring to FIG. 5, the electronic device 100 may enter the camera capture mode in operation 500.

According to one embodiment of the present disclosure, the electronic device 100 may execute a specific application or may enter the camera capture mode according to a camera capture mode entry event such as input of a specific key. When entering the camera capture mode, the electronic device 100 may output a background image 800 received through a camera sensor to the touch screen 190 as illustrated in FIG. 8A. Furthermore, the electronic device 100 may display a capture button 810 to capture the background image output to the touch screen 190. As illustrated in FIG. 8B, when the capture button 810 for capture is selected by an input means such as a finger F or a touch pen, the electronic device 100 may capture the background image 800 which is currently output.

In operation 510, the electronic device 100 may determine whether a capture event is detected.

According to one embodiment of the present disclosure, the capture event detector 230 of the electronic device 100 may detect an input with respect to the capture event such as selection of a capture button or a specific key input to perform the capture.

When the capture event is detected, the electronic device 100 may determine whether the capture event is detected within a predetermined time from entry to the camera capture mode in operation 520.

According to one embodiment of the present disclosure, the capture event detector 230 of the electronic device 100 may determine whether the capture event is detected within a preset time. According to one embodiment, the capture event detector 230 may confirm a selected time point of the capture button 810 as illustrated in FIG. 8B. The capture event detector 230 may determine whether the selected capture button 810 is detected within a predetermined time from the entry to the camera capture mode. For example, the predetermined time may be about two seconds, but the present disclosure is not limited thereto.

According to an embodiment of the present disclosure, the capture event detector 230 may determine whether the selected capture button 810 is detected with a predetermined time from generation of a camera capture mode entry event.

When the capture event is detected within the predetermined time from the entry to the camera capture mode, the electronic device 100 may set an environment for the instant capture in operation 530.

According to one embodiment of the present disclosure, the environment setting controller 220 of the electronic device 100 may set an environment of the electronic device 100 for an instant capture function.

According to one embodiment of the present disclosure, the environment setting for the instant capture may perform at least one of following operations.

First, a processing speed for capture may be increased by increasing the clock frequency of the processor 122. For example, the environment setting controller 220 may perform control such that the clock frequency of the processor 122 is maintained to be greater than that in a normal state.

Second, a processing time required for capture may be reduced by setting a priority of a task for capture to the highest level. For example, the environment setting controller 220 may perform control such that a task for capture is first processed among a plurality of current processed tasks.

Third, a processing time required for an allocation operation of a memory may be reduced by defining a memory necessary for capture as a designated memory area. For example, the environment setting controller 220 may designate a predefined memory area as a memory area to be used for capture.

Fourth, memory release may be performed when a predetermined time elapses or when an instant capture is terminated after a memory area to be used for the capture maintains without the memory release. For example, the environment setting controller 220 may perform the memory release for a continuous instant capture when the predetermined time elapses or when the instant capture is terminated.

As described above, the environment setting controller 220 may perform at least one of the above operations to set environments of the electronic device 100 for the instant capture.

In operation 540, the electronic device 100 may perform the instant capture.

According to one embodiment of the present disclosure, the capture mode controller 240 of the electronic device 100 may perform control such that the environment setting controller 220 performs the instant capture after setting the environment of the electronic device 100 for the instant capture.

According to one embodiment of the present disclosure, the instant capture may denote performance of at least one of following operations.

First, a fixed focusing may be used to capture the image.

Second, thumbnail information on the image generated by the capture is not generated, and update of a database may be omitted.

Third, only basic EXIF information (for example, captured weather, resolution, and the like) on the image generated by the capture may be displayed.

Fourth, a low compression rate may be applied to the image generated by the capture.

Fifth, when entering a camera capture mode, the capture is possible regardless of preview.

When the capture event is detected after the predetermined time from the entry to the camera capture mode, the electronic device 100 may perform normal capture in operation 550.

According to one embodiment of the present disclosure, the environment setting controller 220 of the electronic device 100 may set the environment of the electronic device 100 for the normal capture.

According to one embodiment of the present disclosure, the environment setting for the normal capture may perform at least one of following operations.

First, the environment setting controller 220 may perform control such that the clock frequency of the processor 122 is maintained in a normal state.

Second, the environment setting controller 220 may perform control such that a priority of a task for capture is maintained in the normal state.

Third, the environment setting controller 220 may optimize the use of a memory by using a heap memory as a memory necessary for the capture.

Fourth, the environment setting controller 220 may provide other additional functions such as a filter effect with respect to capture, a face recognition function, and a multi-frame function.

As described above, the environment setting controller 220 may perform at least one of the above operations to set an environment of the electronic device 100 for the normal capture.

In operation 560, the electronic device 100 may perform the normal capture.

According to one embodiment of the present disclosure, the capture mode controller 240 of the electronic device 100 may perform control such that the normal capture is performed after the environment setting controller 220 sets the environment of the electronic device 100 for the normal capture.

According to one embodiment, the normal capture may denote performance of at least one of following operations.

First, AF, CF, or face recognition focusing FDAF may be used to capture the image.

Second, thumbnail information with respect to the image generated by the capture may be generated.

Third, a high compression rate may be applied to the image generated by the capture.

Fourth, when entering the camera capture mode, the electronic device 100 may display a preview to perform the capture.

According to various embodiments of the present disclosure, as described above, the instant capture, the environment setting for the instant capture, the normal capture, and the environment setting for the normal capture are defined, but the present disclosure is not limited thereto. For example, conditions corresponding to the instant capture, the environment setting for the instant capture, the normal capture, and the environment setting for the normal capture may be added or eliminated.

A command set for the respective operations may be stored in the above memory 110 as at least one module. In this case, the modules stored in the memory 110 may be executed by at least one processor 122.

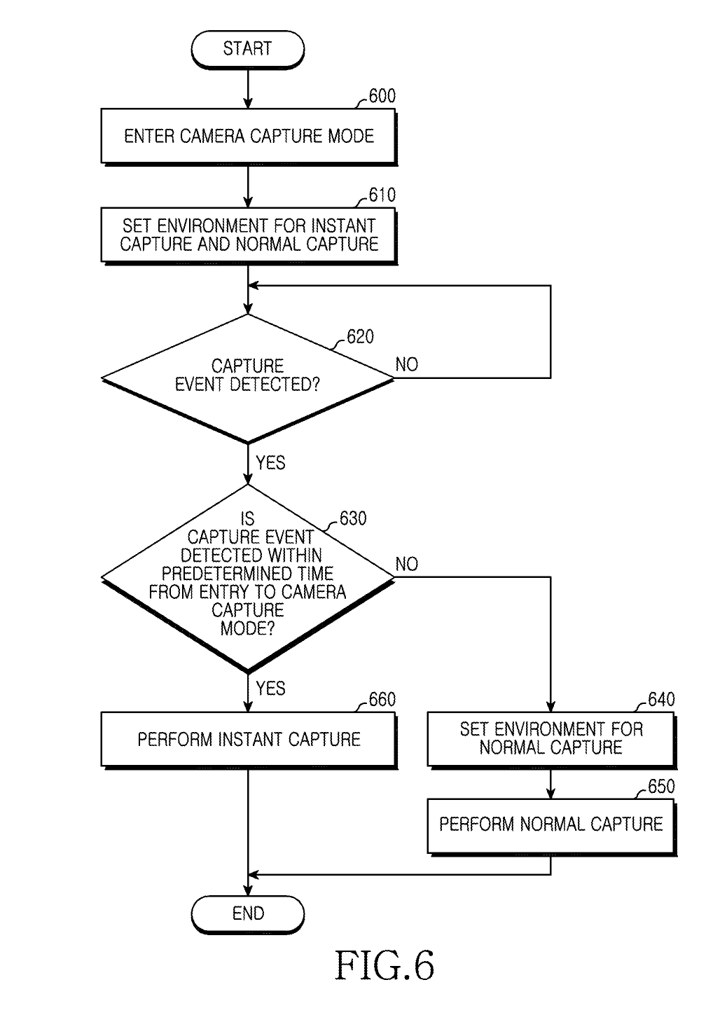

FIG. 6 is a flowchart illustrating a method of operating an electronic device according to one embodiment of the present disclosure.

Referring to FIG. 6, the electronic device 100 may enter the camera capture mode in operation 600.

According to one embodiment of the present disclosure, the electronic device 100 may execute a specific application or may enter the camera capture mode according to a camera capture mode entry event such as input of a specific key. When entering the camera capture mode, the electronic device 100 may output a background image 800 received through a camera sensor to the touch screen 190 as illustrated in FIG. 8A. Furthermore, the electronic device 100 may display a capture button 810 to capture the background image 800 output to the touch screen 190. As illustrated in FIG. 8B, when the capture button 810 for capture is selected by an input means such as a finger F or a touch pen, the electronic device 100 may capture the background image 800 which is currently output.

In operation 610, the electronic device 100 may set environments for an instant capture and a normal capture.

According to one embodiment of the present disclosure, the environment setting controller 220 of the electronic device 100 may set environments of the electronic device 100 for an instant capture function.

According to one embodiment of the present disclosure, the environment setting for the instant capture may perform at least one of following operations.

First, a processing speed for capture may be increased by increasing the clock frequency of the processor 122. For example, the environment setting controller 220 may perform control such that the clock frequency of the processor 122 is maintained to be greater than that in a normal state.

Second, a processing time required for capture may be reduced by setting a priority of a task for capture to the highest level. For example, the environment setting controller 220 may perform control such that a task for capture is first processed among a plurality of current processed tasks.

Third, a processing time required for an allocation operation of a memory may be reduced by defining a memory necessary for capture as a designated memory area. For example, the environment setting controller 220 may designate a predefined memory area as a memory area to be used for capture.

Fourth, memory release may be performed when a predetermined time elapses or when an instant capture is terminated after a memory area to be used for the capture maintains without the memory release. For example, the environment setting controller 220 may perform the memory release for a continuous instant capture when the predetermined time elapses or when the instant capture is terminated.

As described above, the environment setting controller 220 may perform at least one of the above operations to set environments of the electronic device 100 for the instant capture.

In operation 620, the electronic device 100 may determine whether a capture event is detected.

According to one embodiment of the present disclosure, the capture event detector 230 of the electronic device 100 may detect an input with respect to the capture event such as selection of a capture button or a specific key input to perform the capture.

When the capture event is detected, the electronic device 100 may determine whether the capture event is detected within a predetermined time from entry to the camera capture mode in operation 630.

According to one embodiment of the present disclosure, the capture event detector 230 of the electronic device 100 may determine whether the capture event is detected within a preset time.

According to one embodiment of the present disclosure, the capture event detector 230 may confirm a selected time point of the capture button 810 as illustrated in FIG. 8B. The capture event detector 230 may determine whether the selected capture button 810 is detected within a predetermined time from the entry to the camera capture mode. For example, the predetermined time may be about two seconds, but the present disclosure is not limited thereto.

According to an embodiment of the present disclosure, the capture event detector 230 may determine whether the selected capture button 810 is detected with a predetermined time from generation of a camera capture mode entry event.

When the capture event is detected after the predetermined time from the entry to the camera capture mode, the electronic device 100 may perform normal capture in operation 640.

According to one embodiment of the present disclosure, the environment setting controller 220 of the electronic device 100 may set the environment of the electronic device 100 for the normal capture.

According to one embodiment of the present disclosure, the environment setting for the normal capture may perform at least one of following operations.

First, the environment setting controller 220 may perform control such that the clock frequency of the processor 122 is maintained in a normal state.

Second, the environment setting controller 220 may perform control such that a priority of a task for capture is maintained in the normal state.

Third, the environment setting controller 220 may optimize the use of a memory by using a heap memory as a memory necessary for the capture.

Fourth, the environment setting controller 220 may provide other additional functions such as a filter effect with respect to capture, a face recognition function, and a multi-frame function.

As described above, the environment setting controller 220 may perform at least one of the above operations to set an environment of the electronic device 100 for the normal capture.

In operation 650, the electronic device 100 may perform the normal capture.

According to one embodiment of the present disclosure, the capture mode controller 240 of the electronic device 100 may perform control such that the normal capture is performed.

According to one embodiment of the present disclosure, the normal capture may denote performance of at least one of following operations.

First, AF, CF, or face recognition focusing FDAF may be used to capture the image.

Second, thumbnail information with respect to the image generated by the capture may be generated.

Third, a high compression rate may be applied to the image generated by the capture.

Fourth, when entering the camera capture mode, the electronic device 100 may display a preview to perform the capture.

When the capture event is detected within the predetermined time from the entry to the camera capture mode, the electronic device 100 may perform the instant capture in operation 660.

According to one embodiment of the present disclosure, the instant capture may denote performance of at least one of following operations.

First, a fixed focusing may be used to capture the image.

Second, thumbnail information on the image generated by the capture is not generated, and update of a database may be omitted.

Third, only basic EXIF information (for example, captured weather, resolution, and the like) on the image generated by the capture may be displayed.

Fourth, a low compression rate may be applied to the image generated by the capture.

Fifth, when entering a camera capture mode, the capture is possible regardless of preview.

According to various embodiments of the present disclosure, as described above, the instant capture, the environment setting for the instant capture, the normal capture, and the environment setting for the normal capture are defined, but the present disclosure is not limited thereto. For example, conditions corresponding to the instant capture, the environment setting for the instant capture, the normal capture, and the environment setting for the normal capture may be added or eliminated.

A command set for the respective operations may be stored in the above memory 110 as at least one module. In this case, the modules stored in the memory 110 may be executed by at least one processor 122.

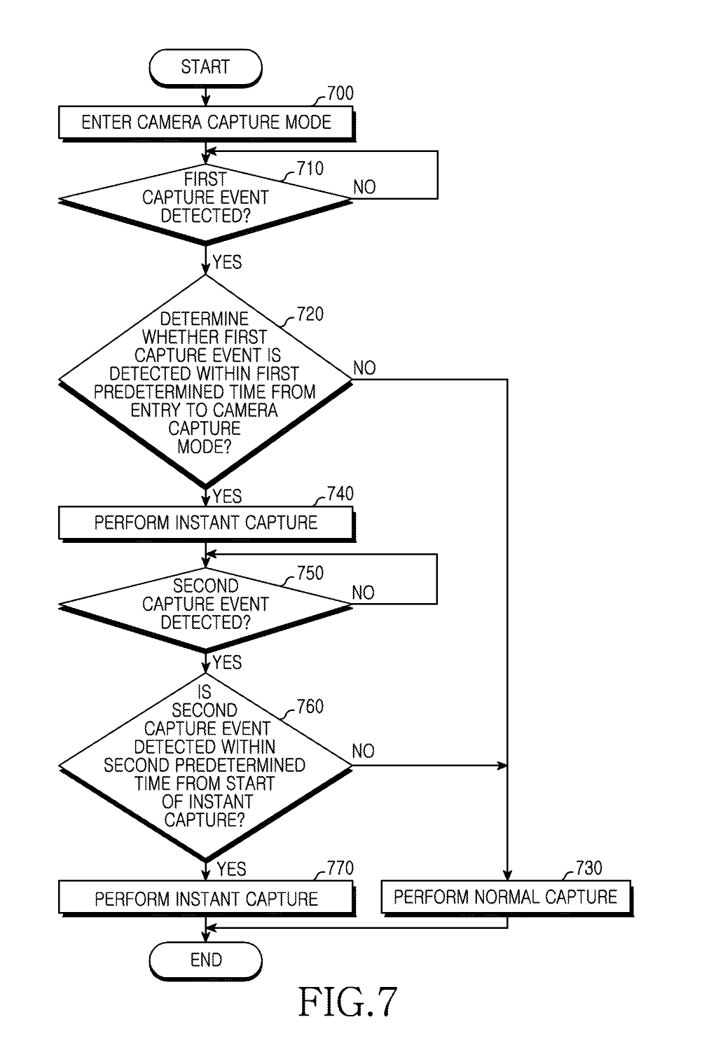

FIG. 7 is a flowchart illustrating a method of operating an electronic device according to one embodiment of the present disclosure.

Referring to FIG. 7, the electronic device 100 may enter the camera capture mode in operation 700.

According to one embodiment of the present disclosure, the electronic device 100 may execute a specific application or may enter the camera capture mode according to a camera capture mode entry event such as input of a specific key. When entering the camera capture mode, the electronic device 100 may output a background image 800 received through a camera sensor to the touch screen 190 as illustrated in FIG. 8A. Furthermore, the electronic device 100 may display a capture button 810 to capture the background image output to the touch screen 190. As shown in FIG. 8B, when the capture button 810 for capture is selected by an input means such as a finger F or a touch pen, the electronic device 100 may capture the background image 800 which is currently output.

In operation 710, the electronic device 100 may determine whether a first capture event is detected.

According to one embodiment of the present disclosure, the capture event detector 230 of the electronic device 100 may detect an input with respect to the first capture event such as selection of a capture button or a specific key input to perform the capture.

When the first capture event is detected, the electronic device 100 may determine whether the first capture event is detected within a first predetermined time from entry to the camera capture mode in operation 720.

According to one embodiment of the present disclosure, the capture event detector 230 of the electronic device 100 may determine whether the first capture event is detected within a preset time.

According to one embodiment of the present disclosure, the capture event detector 230 may confirm a selected time point of the capture button 810 as shown in FIG. 8B. The capture event detector 230 may determine whether the selected capture button 810 is detected within the first predetermined time from the entry to the camera capture mode. For example, the first predetermined time may be about two seconds, but the present disclosure is not limited thereto.

According to an embodiment of the present disclosure, the capture event detector 230 may determine whether the selected capture button 810 is detected with the first predetermined time from generation of a camera capture mode entry event.

When the capture event is detected after the first predetermined time from the entry to the camera capture mode, the electronic device 100 may perform normal capture in operation 730.

According to one embodiment of the present disclosure, when the first capture event is detected after the first predetermined time from the entry to the camera capture mode, the capture mode controller 240 of the electronic device 100 may perform control such that the normal capture is performed.

According to one embodiment of the present disclosure, the normal capture may denote performance of at least one of following operations.

First, AF, CF, or face recognition focusing FDAF may be used to capture the image.

Second, thumbnail information with respect to the image generated by the capture may be generated.

Third, a high compression rate may be applied to the image generated by the capture.

Fourth, when entering the camera capture mode, the electronic device 100 may display a preview to perform the capture.

When the first capture event is detected within the first predetermined time from the entry to the camera capture mode, the electronic device 100 may perform the instant capture in operation 740.

According to one embodiment of the present disclosure, when the first capture event is detected within the first predetermined time from the entry to the camera capture mode, the capture mode controller 240 may perform control such that the instant capture is performed.

According to one embodiment of the present disclosure, the instant capture may denote performance of at least one of following operations.

First, a fixed focusing may be used to capture the image.

Second, thumbnail information on the image generated by the capture is not generated, and update of a database may be omitted.

Third, only basic EXIF information (for example, captured weather, resolution, and the like) on the image generated by the capture may be displayed.

Fourth, a low compression rate may be applied to the image generated by the capture.

Fifth, when entering a camera capture mode, the capture is possible regardless of preview.

In operation 750, the electronic device 100 may determine whether a second capture event is detected.

According to one embodiment of the present disclosure, the capture event detector 230 of the electronic device 100 may detect an input with respect to the second capture event such as selection of a capture button or a specific key input to perform the capture.

When the second capture event is detected, the electronic device 100 may determine whether the second capture event is detected within a second predetermined time from start of the instant capture in operation 760.

According to one embodiment of the present disclosure, the capture event detector 230 of the electronic device 100 may determine whether the capture event is detected within a preset time from the start of the instant capture.

According to one embodiment of the present disclosure, the capture event detector 230 may confirm a selected time point of the capture button 810 as shown in FIG. 8B. The capture event detector 230 may determine whether the selected capture button 810 is detected within the second predetermined time from the start of the instant capture. For example, the second predetermined time may be about two seconds, but the present disclosure is not limited thereto.

When the second capture event is detected after the second predetermined time from the start of the instant capture, the electronic device 100 may perform the normal capture in operation 730.

According to one embodiment of the present disclosure, when the second capture event is detected after the second predetermined time from the start of the instant capture, the capture mode controller 240 of the electronic device 100 may perform control such that the normal capture is performed.

According to one embodiment of the present disclosure, the normal capture may denote performance of at least one of following operations.

First, AF, CF, or face recognition focusing FDAF may be used to capture the image.

Second, thumbnail information with respect to the image generated by the capture may be generated.

Third, a high compression rate may be applied to the image generated by the capture.

Fourth, when entering the camera capture mode, the electronic device 100 may display a preview to perform the capture.

When the second capture event is detected within the second predetermined time from the start of the instant capture, the electronic device 100 may perform the instant capture in operation 770.

According to one embodiment of the present disclosure, when the second capture event is detected within the second predetermined time from the start of the instant capture, the capture mode controller 240 of the electronic device 100 may perform control such that the instant capture is performed.

According to one embodiment of the present disclosure, the instant capture may denote performance of at least one of following operations.

First, a fixed focusing may be used to capture the image.

Second, thumbnail information on the image generated by the capture is not generated, and update of a database may be omitted.

Third, only basic EXIF information (for example, captured weather, resolution, and the like) on the image generated by the capture may be displayed.

Fourth, a low compression rate may be applied to the image generated by the capture.

Fifth, when entering a camera capture mode, the capture is possible regardless of preview.

According to various embodiments of the present disclosure, as described above, although the instant capture and the normal capture are defined, the present disclosure is not limited thereto. For example, conditions corresponding to the instant capture and the normal capture may be added or eliminated.

Furthermore, the electronic device 100 may continuously perform the instant capture through the algorithm as described above. The environment for the instant capture may be set before or after an operation of detecting the capture event. The environment for the instant capture may be set in real time.

The command set for the respective operations may be stored in the above memory 110 as at least one module. In this case, the modules stored in the memory 110 may be executed by at least one processor 122

According to one embodiment of the present disclosure, respective modules may be configured by software, firmware, hardware, or a combination thereof. Some or entire modules are configured in one entity, and may equally perform functions of the respective modules. According to one embodiment of the present disclosure, respective operations may be sequentially, repeatedly, and in parallel performed. Some operations may be omitted or other operations are added so that the operations may be executed. For example, the respective operations may be executed by the modules according to one embodiment of the present disclosure.

When the modules are implemented by software, a non-temporary computer readable storing medium for storing at least one program (software module) may be provided. At least one program stored in the computer readable storing medium may be executed by at least one processor in an electronic device. The at least one program may include a command which allows the electronic device 100 to execute the methods according to various embodiments of the present disclosure.

The program (software module, software) may be stored in a random access memory, a nonvolatile memory such as a flash memory, a Read-Only Memory (ROM), an Electrically Erasable Programmable Read-Only Memory (EEPROM), a magnetic disc storage device, a Compact Disc Read-Only Memory (CD-ROM), a Digital Versatile Disc (DVD), other types of optical storage devices, or a magnetic cassette. The program may be stored in a memory configured by some or all of the above memories. Furthermore, a plurality of configuration memories may be included.

The program may be stored in an attachable storage device approaching the electronic device through a communication network such as Internet, intranet, LAN, WLAN, or SAN or a communication network configured by a combination thereof. The storage device may access the electronic device through an external port device.

In addition, a separate storage device on the communication network may access the electronic device.

According to various embodiments of the present disclosure, methods for capturing an image, which are intuitively operated with immediacy, and electronic devices thereof may be provided.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
entering a camera capture mode according to a camera capture mode entry event;
detecting a capture event;
determining whether the capture event is detected within a predetermined time from generation of the camera capture mode entry event or the entry of the camera capture mode; and
performing an instant capture when the capture event is detected within the predetermined time, and performing a normal capture when the capture event is detected after the predetermined time.

2. The method of claim 1, wherein performing of the instant capture uses fixed focusing.

3. The method of claim 1, wherein performing of the instant capture does not generate thumbnail information on an image generated by the instant capture.

4. The method of claim 1, wherein the performing of the instant capture comprises omitting at least a part of contents of EXchangeable Image File Format (EXIF) information on an image generated by the instant capture.

5. The method of claim 1, wherein the performing of the instant capture comprises applying a low compression rate to an image generated by the instant capture.

6. The method of claim 1, wherein the performing of the instant capture comprises performing the instant capture in a state that a preview is not displayed.

7. The method of claim 1, further comprising setting an environment of a camera for the instant capture and the normal capture after the entering of the camera capture mode.

8. The method of claim 7, wherein the setting of the environment of the camera for the instant capture comprises increasing the frequency of a clock of a processor of the electronic device to be greater than the frequency of the clock in a normal state.

9. The method of claim 7, wherein setting the environment of the camera for the instant capture comprises setting a priority of a task for the instant capture to the highest level.

10. The method of claim 7, wherein the setting of the environment of the camera for the instant capture comprises using a memory area to be used in the instant capture as a predefined memory area.

11. The method of claim 7, wherein the setting of the environment of the camera for the instant capture comprises maintaining a memory area to be used for the capture without the memory release.

12. The method of claim 1, further comprising setting an environment of a camera for the instant capture and the normal capture after determining whether the capture event is detected within a predetermined time from the generation of the camera capture mode entry event or the entry of the camera capture mode.

13. The method of claim 1, further comprising, when performing the instant capture:
detecting a second capture event;
determining whether the second capture event is detected within a second predetermined time from a start of the instant capture; and
further performing the instant capture when the second capture event is detected within the second predetermined time.

14. An electronic device comprising:
at least one camera module;
a memory; and
at least one processor,
wherein the processor is configured to:
enter a camera capture mode according to a camera capture mode entry event, detect a capture event, determine whether the capture event is detected within a predetermined time from generation of the camera capture mode entry event or the entry of the camera capture mode, and perform control such that an instant capture is performed when the capture event is detected within the predetermined time.

15. The electronic device of claim 14, wherein the capture event comprises input of a capture button or input of a specific key.

16. The electronic device of claim 14, wherein the processor is further configured to set an environment of a camera for the instant capture after the processor enters the camera capture mode.

17. The electronic device of claim 14, wherein the processor is further configured to set an environment of a camera for the instant capture after the processor determines whether the capture event is detected within a predetermined time from generation of the camera capture mode entry event or the entry of the camera capture mode.

18. The electronic device of claim 14, wherein when performing the instant capture, the processor is further configured to:
detect a second capture event, determine whether the second capture event is detected within a second predetermined time from a start of the instant capture, and further perform the instant capture when the second capture event is detected within the second predetermined time.

19. A method of an electronic device, the method comprising:
entering a camera capture mode according to a camera capture mode entry event;
setting an environment of a camera for an instant capture and a normal capture;
detecting a capture event;
determining whether the capture event is detected within a predetermined time from the entry of the camera capture mode; and
performing an instant capture when the capture event is detected within the predetermined time, and performing a normal capture when the capture event is detected after the predetermined time.

20. The method of claim 19, further comprising, when performing the instant capture:
detecting a second capture event;
determining whether the second capture event is detected within a second predetermined time from start of the instant capture; and
further performing the instant capture when the second capture event is detected within the second predetermined time.
